(19) United States
(12) Patent Application Publication
(10) Pub. No.: US 2004/0166207 A1
(43) Pub. Date: Aug. 26, 2004

(54) Food kit for components of chilled and frozen desserts

(75) Inventors: Michael J. Vincent, Dublin, CA (US); Robert W. Martin JR., San Ramon, CA (US); Rachelle M. Smeester-Karpeles, Hayward, CA (US); Dana M. Morris, Walnut Creek, CA (US); Alger C. Marable, Antioch, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dreyer's Grand Ice Cream, Inc., Oakland, CA

(21) Appl. No.: 10/628,877

(22) Filed: Jul. 28, 2003

Related U.S. Application Data
(60) Provisional application No. 60/399,857, filed on Jul. 31, 2002.

(51) Int. Cl. C12C 1/027

(52) U.S. Cl. 426/106

(57) ABSTRACT

A food kit for the components or ingredients of a ready-to-make, chilled or frozen dessert. The kit preferably includes a plurality of compartments for the ingredients with one of the compartments being filled with a dessert component such as ice cream, yogurt or pudding. The second compartment is filled with a component such as cookies or wafers and the third with a topping component such as fudge, syrup, or bits of candy. In use, the consumer may create a dessert with any number of combinations of the components.

### CROSS-REFERENCES TO RELATED APPLICATIONS

This application is a non-provisional application and claims the benefit of Application No. 60/399,857, filed Jul. 31, 2002, entitled “FOOD KIT FOR COMPONENTS OF CHILLED AND FROZEN DESSERTS”, (Attorney Docket No. 020903-014700US) which disclosure is incorporated herein by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention pertains to the field of food kits, and more particularly, to the field of food kits for the components of chilled and frozen desserts.

2. Description of the Prior Art

Food kits are commonly used to hold the ingredients of meat sandwiches as well as cheese and cracker snacks. They have also been used to contain the ingredients of pizzas. Still other kits have been designed to hold the components of a breakfast cereal including the milk. Kits for dessert items such as ice cream are less common and for the most part, only provide a limited number of companion ingredients and ways to assemble and eat them. For example, one kit contains ice cream, but the only associated components are solid, particulate fragments of other food stuffs such as nuts. Further, this kit only provides for the consumption of the ice cream and particulates using a spoon, essentially just a sundae kit. The consumer in this regard is greatly limited in the variety of dessert components and the manners in which they may be assembled and eaten.

With these and other drawbacks in mind, the present invention was developed. With the present invention, a food kit is provided having a plurality of components for a ready-to-make, chilled or frozen dessert. The kit includes compartments for dessert ingredients such as, for example, ice cream, yogurt and pudding, cookies and wafers, and toppings such as fudge, syrup, and bits of candy and dough. With the kit of the present invention, a wide variety of dessert combinations may be assembled and eaten by the consumer in any number of ways beyond simply using a spoon.

### BRIEF SUMMARY OF THE INVENTION

The present invention provides a food kit for the components or ingredients of a chilled or frozen dessert. The kit preferably includes a plurality of compartments for the ingredients. In the preferred embodiments, one of the compartments is filled with a first or primary dessert component such as, for example, ice cream, yogurt or pudding. The second compartment is filled with a secondary dessert component such as cookies or wafers and the third with a topping component such as fudge, syrup, or bits of candy. In use, the consumer may create a dessert with any number of combinations of the ingredients. For example, the consumer may manually dip one of the cookies into the ice cream to scoop out a desired amount and then dip the ensemble into the fudge topping. The ensemble may then be eaten as is or a second cookie easily added to make an ice cream sandwich. A spoon is also conveniently provided with the kit for the consumer to use if desired to create still other combinations of the dessert components.

Two embodiments of the ready-to-make dessert kit are provided. In the first embodiment, the compartment for the ice cream or yogurt has scalloped or curved sides that substantially match the curved shape and size of the cookie or wafer. In this manner, the cookie or wafer may be used to scoop out virtually all of the ice cream from its compartment. The cookies in the first embodiment are stacked in their compartment with the spoon positioned atop them. Side or ear portions are then provided in the cookie compartment that receive the ends of the spoon to help hold it in place. Additionally, the ear portions slope downwardly and inwardly to provide opposing spaces into which the consumer may insert his or her fingers to easily grip and remove the individual cookies. In the second embodiment of the kit, the shapes of the compartments are somewhat simplified and the cookie compartment has a slanted side to hold the cookies in a shingled manner for easy pickup by the consumer.

Other features and advantages of the present invention will be apparent in view of the following detailed description of preferred exemplary embodiments.

### BRIEF DESCRIPTION OF THE DRAWINGS

FIG. 1 is a perspective view of a first embodiment of the food kit of the present invention.

FIG. 2 is a top plan view of the food kit of FIG. 1 filled with the components for a chilled or frozen dessert.

FIG. 3 is view similar to FIG. 2 showing details of the compartments for the ingredients of the dessert before they are filled.

FIGS. 4-6 sequentially show one manner in which a cookie in the food kit of FIG. 1 may be used to scoop out a desired amount of the ice cream from its compartment.

FIGS. 7-10 illustrate additional details of the manner in which the cookies of the food kit of FIG. 1 may be used to scoop out virtually all of the ice cream from its compartment.

FIGS. 11-12 show a further manner in which the cookies of the food kit of FIG. 1 may be used to laterally swipe across the sidewalls of the ice cream compartment.

FIG. 13 is a bottom view of the food kit of FIG. 1.

FIGS. 14-16 illustrate the manner in which the cookie compartment is shaped to hold a stack of cookies in its central, cylinder portion. FIG. 14 further shows how the side or ear portions of the cookie compartment may be used to firmly hold the ends of a spoon positioned atop the cookie stack. FIGS. 15-16 additionally illustrate the downwardly and inwardly sloping surfaces of the opposing ear portions, which surfaces provide spaces for the consumer to insert his or her fingers to easily grip and remove a cookie from the stack.

FIG. 17 is a perspective view of a second embodiment of the food kit of the present invention.

FIG. 18 is a top plan view thereof.

FIG. 19 is a cross-section view taken along line 19-19 of FIG. 18 showing the cookies positioned in a shingled manner for easy pickup by the consumer.

FIG. 20 is view similar to FIG. 18 showing details of the compartments for the ingredients of the dessert before they are filled.

FIG. 21 is a bottom view of the food kit of FIG. 17.

### DETAILED DESCRIPTION OF THE INVENTION

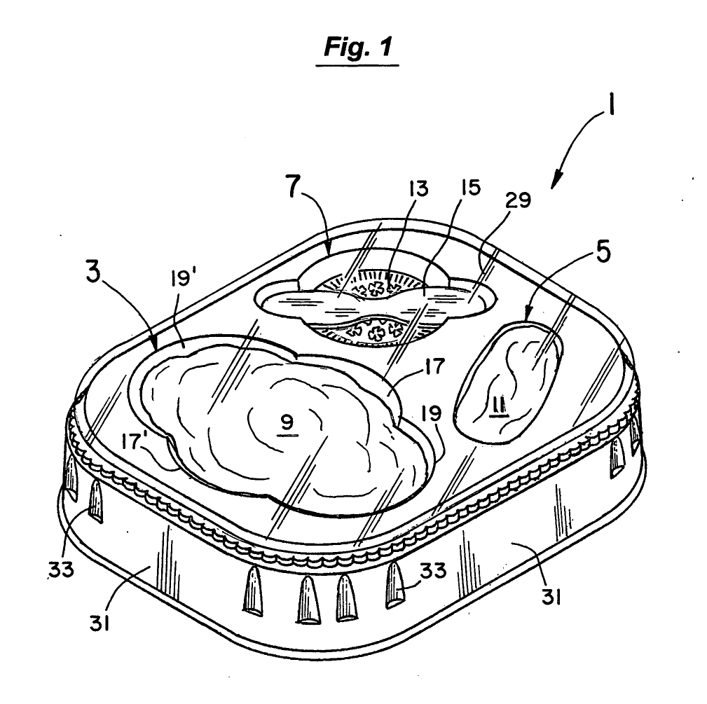

As best seen in FIGS. 1-3, the food kit 1 of the present invention preferably has three compartments 3, 5, and 7 for the ingredients or components of a chilled or frozen dessert. The compartments 3, 5, and 7 may hold various dessert components and in the illustrated ones of FIGS. 1 and 2, compartment 3 is shown filled with ice cream 9, compartment 5 filled with a fudge topping 11, and compartment 7 filled with cookies 13 and an overlying spoon 15. Those skilled in the art will understand that other foods or toppings may be used as desired.

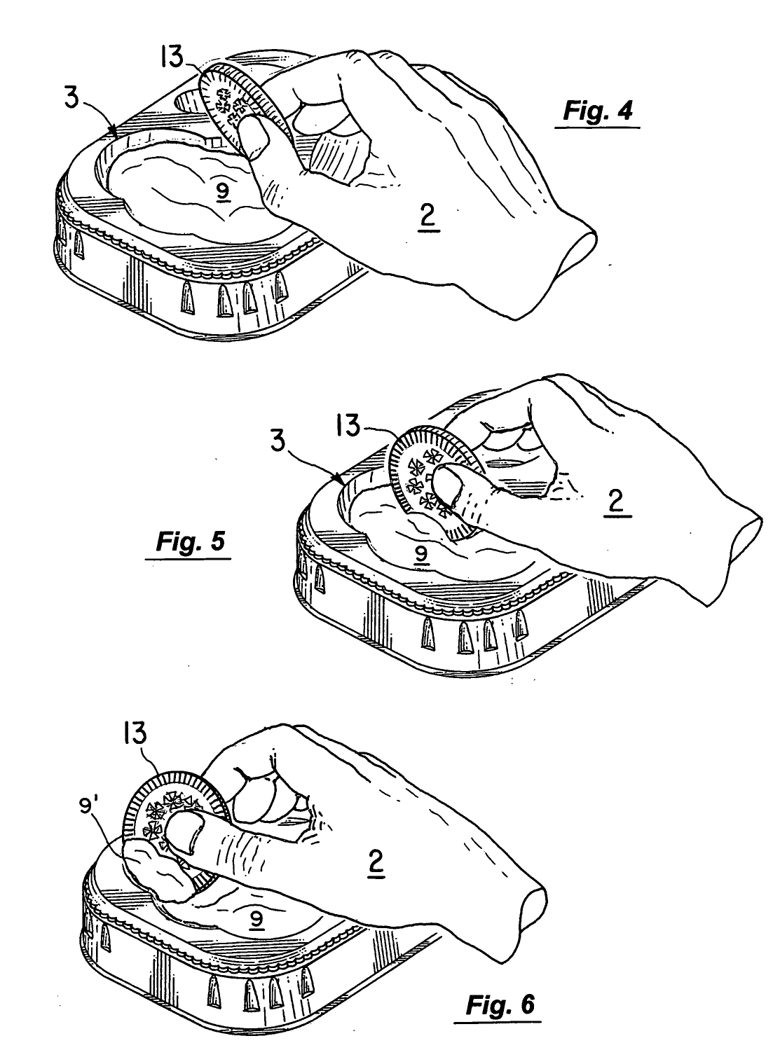

Compartment 3 for the ice cream 9 preferably has scalloped or similarly shaped sidewalls 17, 17′, 19, and 19′ that substantially match the shape of the perimeter of the cookies 13. For the rounded cookies 13 illustrated in FIGS. 1-2, the sidewalls 17, 17′, 19, and 19′ of the ice cream compartment 9 are substantially spherical sections. In this manner and as illustrated in FIGS. 4-12, the cookies 13 may be used to easily and effectively scoop virtually all of the ice cream 9 from the ice cream compartment 3.

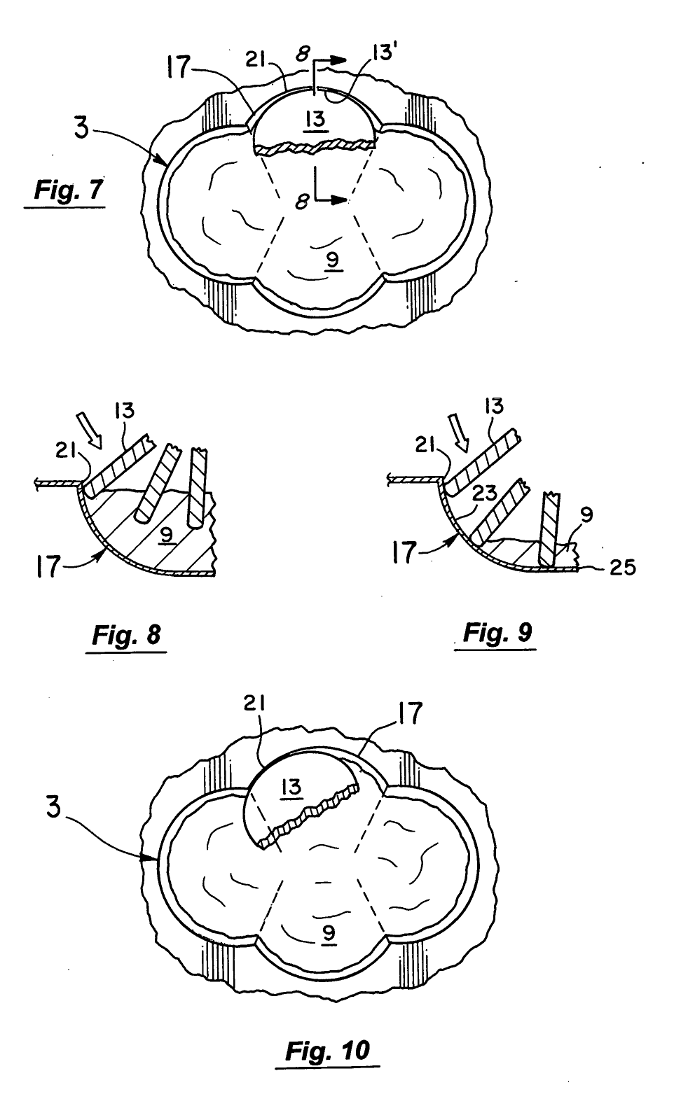

More specifically as best seen in FIGS. 4-6, the round cookie 13 may be manually gripped by the consumer 2 and sequentially moved to scoop out a desired amount 9′ of ice cream 9. In doing so, the consumer 2 may initially align the perimeter 13′ of the cookie 13 with the substantially mating, upper edge 21 of the sidewall 17 (see FIGS. 4 and 7). The cookie 13 may then be run down into the ice cream 9 (see FIGS. 5 and 8) and once the desired amount 9′ of ice cream 9 has been scooped out as in FIG. 6, the cookie 13 and scooped ice cream 9′ may be dipped into the fudge topping 11 in compartment 5 (see FIG. 2). The assembled dessert could be eaten as is or a second cookie 13 placed over it to make an ice cream sandwich. In subsequent passes, a cookie 13 may be run along the substantially mating surface 23 (see FIG. 9) of the sidewall 17 all the way down to the bottom 25 of the sidewall 17 to scoop out virtually all of the remaining ice cream 9 in the compartment.

As indicated above, the consumer 2 may assemble and eat the ingredients 9, 11, 13 of the dessert in any desired order or combination. For example, he or she could dip the cookie 13 into the fudge or other topping 11 and then scoop out the ice cream 9. Alternatively, the topping 11 could be first spooned over the ice cream 9 in the compartment 3 before scooping the cookie 13. The spoon 15 could also be used at any stage to dip out the fudge topping 11 or ice cream 9.

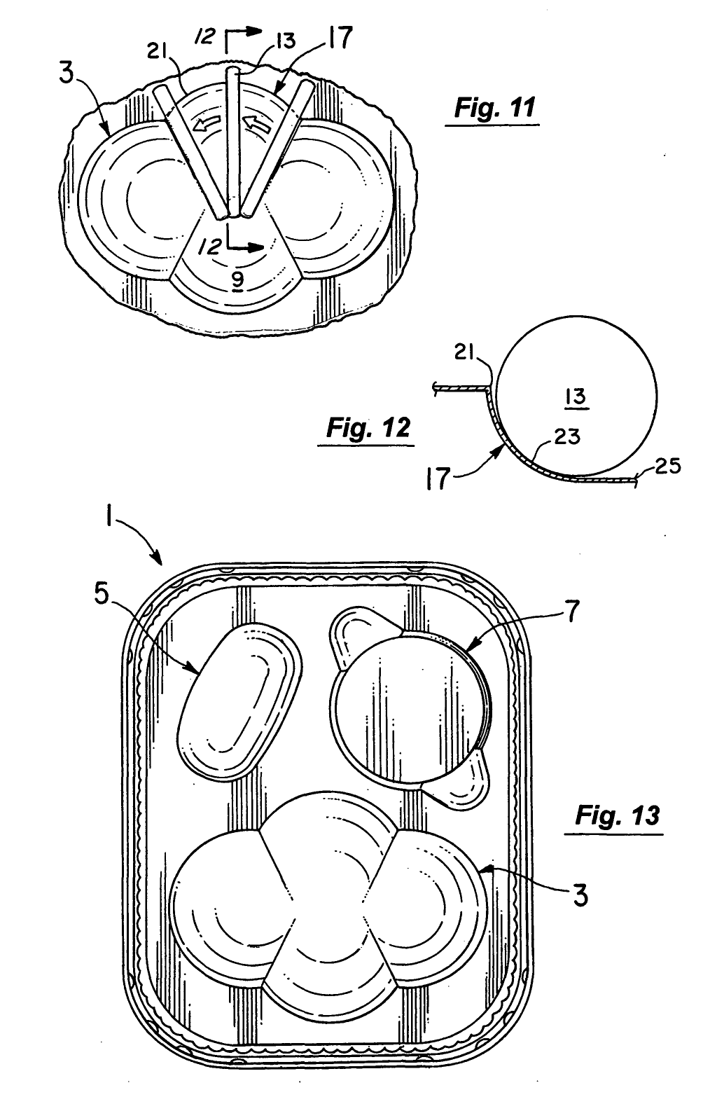

The general matching of the shapes of the sidewalls 17, 17′, 19, and 19′ of the ice cream compartment 3 to the shape of the cookie 13 discussed above results in a very easy and efficient use of the food kit 1. In the illustrated embodiment of FIGS. 4-8, the cookie 13 has a round perimeter 13′ (see FIG. 7) and the sidewall 17 of the compartment 3 is a matching, substantially spherical section. The radii of the cookie 13 and sidewall 17 may actually be the same but the radius of the cookie 13 is preferably slightly less as best seen in FIG. 7. Nevertheless, the cookie 13 may be positioned as in FIG. 10 slightly off to the side to contact any portion of the edge 21 and sidewall 17 to remove any ice cream 9 not scooped on the prior passes. Further, the shapes and sizes of the cookie 13 and sidewall 17 as indicated above substantially match and mate. This is preferably the case both about the top edge or rim 21 of the sidewall 17 (see FIG. 7) as well as down the sidewall surface 23 to the bottom 25 thereof (see FIG. 9). Consequently and in addition to the downward scooping action of FIGS. 4-9, the consumer may also swipe the cookie 13 laterally or horizontally across the sidewall 17 (see FIGS. 11-12). As in FIG. 10, the cookie 13 in FIG. 11 may be positioned anywhere along the sidewall 17 to reach all of the ice cream 9 therein.

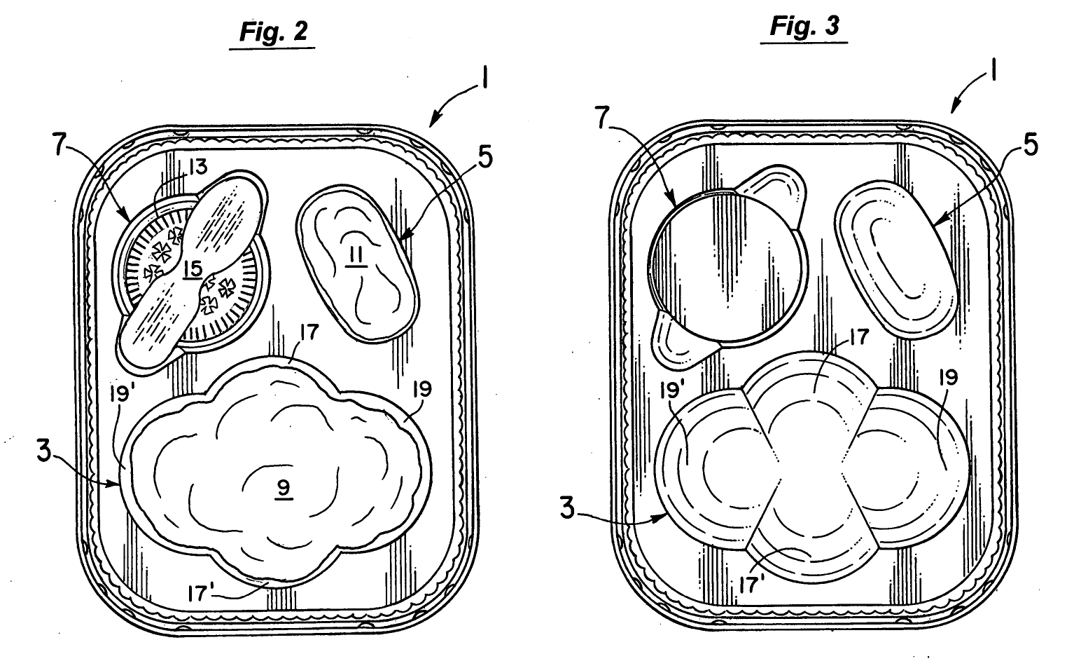

It is noted that the opposing sidewalls 17 and 17′ are preferably mirror images of one another and may be slightly different in size from the opposing sidewalls 19 and 19′ (see FIGS. 2-3). As illustrated, sidewalls 19 and 19′ are slightly larger than sidewalls 17 and 17′ yet the cookie 13 may still be used to scoop out virtually all of the ice cream 9 adjacent sidewalls 19 and 19′ in the same manner as FIGS. 7-12.

One advantage of the clover pattern (i.e., pairs of opposing sidewalls 17-17′ and 19-19′ 19′ in FIG. 2) is that it allows the consumer to scoop the ice cream 9 in any number of directions depending upon his or her preference. That is, the consumer may scoop the cookie 13 always down the sidewalls 17, 17′, 19, and 19′ toward the center of the ice cream compartment 3 if desired. He or she could also make passes completely across the ice cream compartment 3 in the same direction (e.g., from right-to-left down sidewall 19 in FIG. 2 and with the same or different cookie 13 up the opposing sidewall 19′). The consumer could also scoop in the opposite directions if preferred or toward/away from himself or herself (e.g., 17 to 17′ or 17′ to 17 in FIG. 2). The ice cream compartment 3 in this regard is illustrated with four, curved sidewalls 17, 17′, 19, and 19′ but could have more or fewer. The curved sidewalls are also shown in orthogonal relationship to each other (e.g., the spherical section of sidewall 17 faces that of sidewall 17′ and is perpendicular to the facing directions of the spherical sections 19 and 19′). However, the sidewalls could be oriented in any number of ways to each other. FIG. 13 is a bottom view of the food kit 1 further illustrating the overall shapes of the compartments 3, 5, and 9. It is noted that the cookies 13 have been shown for illustrative purposes as having a round, circular perimeter but they could be virtually any shape (e.g., elongated with rounded ends or rectangular). In this regard, it is preferred that the shape of the sidewalls 17, 17′, 19, and 19′ then substantially match at least a portion of the perimeter of the cookie (e.g., the rounded ends or sides of the rectangle) so that essentially all of the ice cream may be scooped out of the ice cream compartment.

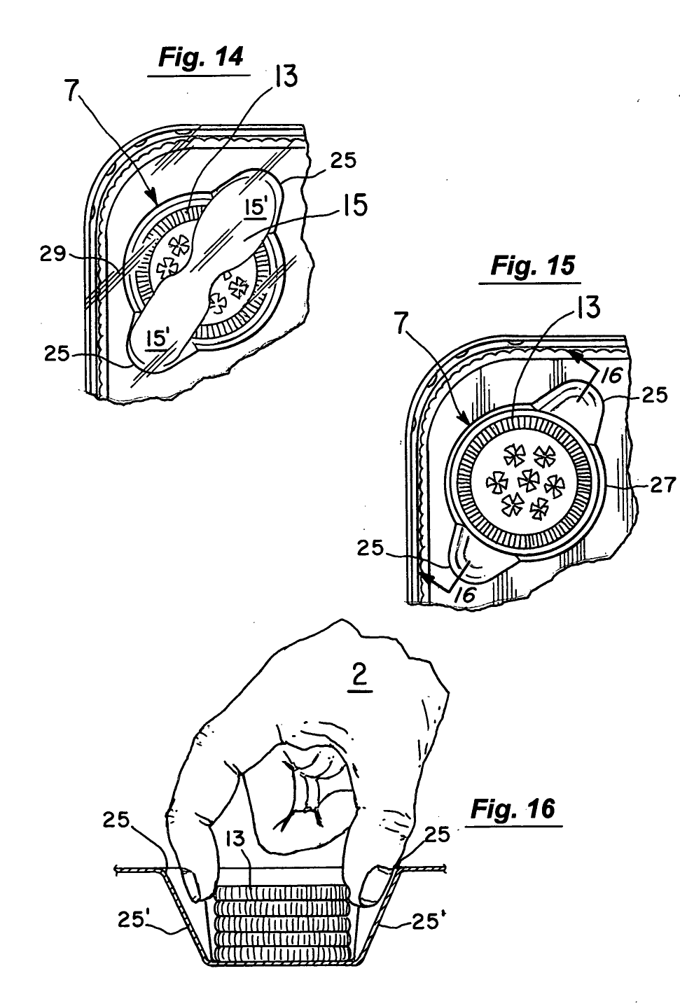

FIGS. 14-16 illustrate an advantage of the shape of the cookie compartment 7 in which side or ear portions 25 are provided with downwardly sloping surfaces 25′ (see FIGS. 15-16). When the central, cylindrical portion 27 of the compartment 7 is filled with cookies 13, the ear portions 25 conveniently receive and firmly hold the ends 15′ of the spoon 15 in place atop the stack of cookies 13 (see FIG. 14). This not only creates a neat appearance but also with the film cover 29 sealed across the kit 1 to hold the spoon 15 in place, movement of the cookies 13 is kept to a minimum helping to limit breakage and rattling of the cookies 13. In use with the film 29 and spoon 15 removed, the downwardly and inwardly sloping surfaces 25′ of the ear portions 25 (see FIG. 16) provide convenient spaces to permit the consumer 2 to easily place his or her fingers on each side of a cookie 13 to grip and remove the cookie 13. It is noted that the film 29 is initially tightly sealed not only about the perimeter of the kit 1 but also between the compartments 3, 5, and 7 thereof.

The kit 1 of FIGS. 1-16 preferably has a full return of the sides 31 (see FIG. 1) for increased stability (i.e., the kit 1 will support itself on a flat surface much like a water bowl). Further, indents or spacers 33 are preferably provided in the sides 31 so the empty kits 1 may be stacked or nested on one another and then easily separated for filling without binding or sticking to each other.

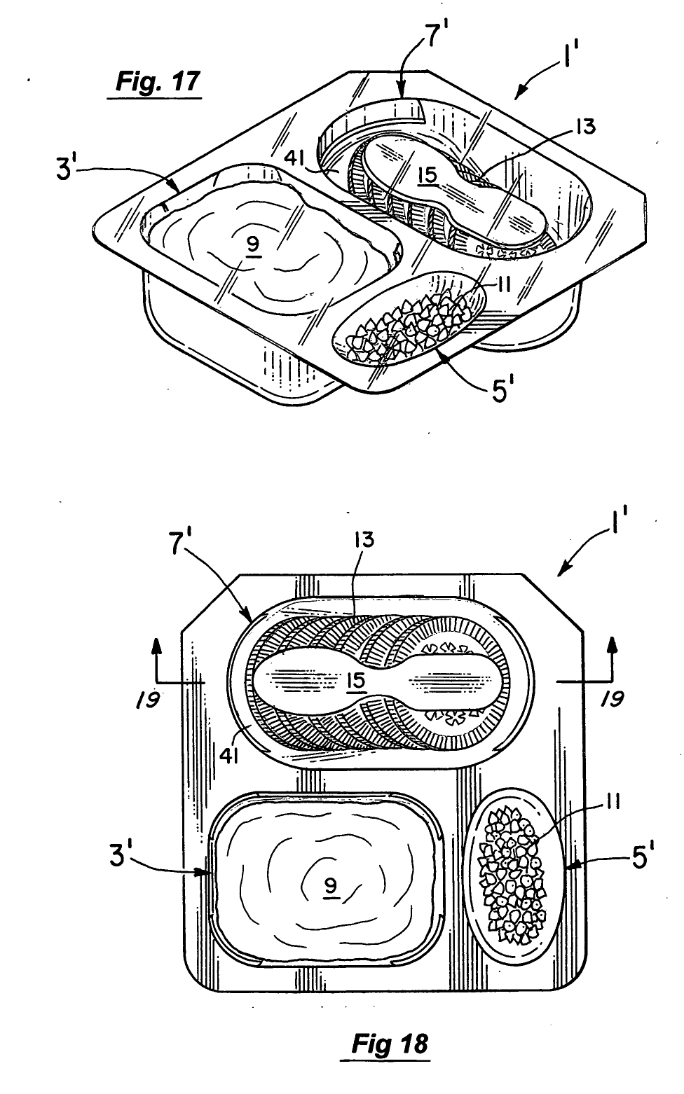

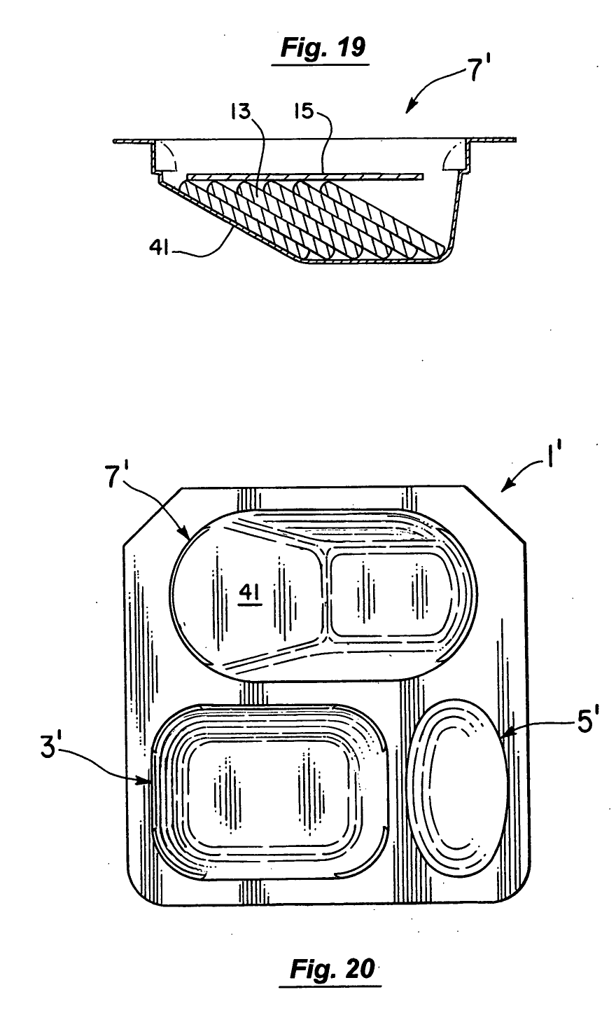

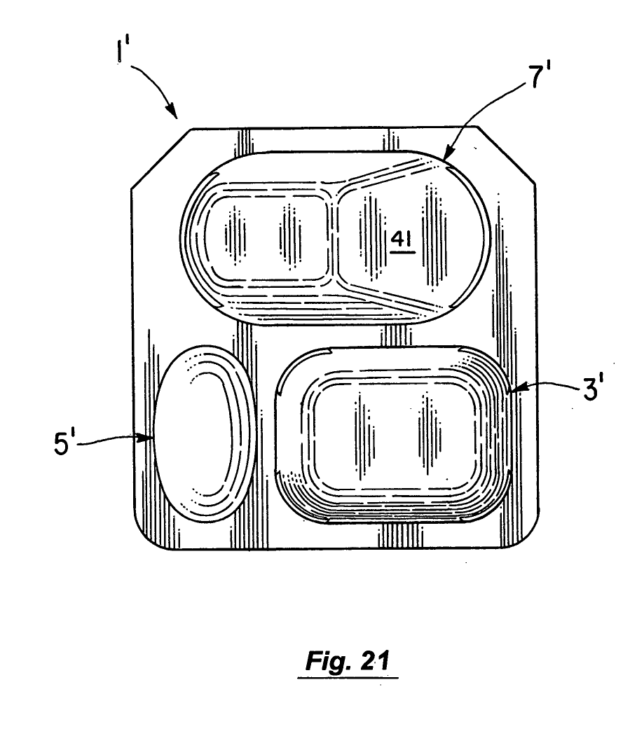

In FIGS. 17-22, a second embodiment 1′ of the food kit is illustrated. As shown, the compartments 3′, 5′, and 7′ for the ice cream 9, topping 11, and cookies 13/spoon 15 have shapes that may be easily formed during manufacture. The topping 11 is illustrated as being bits or chips of chocolate but could be other candies, dough, or similar pieces. The topping 11 could also be fudge, syrup, or the like as in kit 1 and the cookies 13 could be wafers, crackers, or similar items if desired. The cookie compartment 7′ of food kit 1′ as best seen in FIGS. 17-19 is preferable provided with a ramp or slanted side 41 (see FIG. 19) to hold the cookies 13 in a shingled manner for easy pickup by the consumer. FIGS. 20 and 21 are top and bottom views of the food kit 1′ further illustrating the shapes of the compartments 3′, 5′, and 9′.

Both embodiments 1 and 1′ of the dessert kit of the present invention are designed to be chilled or frozen (e.g., chilled around 32° F. or frozen to −10° F. or −20° F.) depending upon the particular components (e.g., ice cream or yogurt) of the dessert. In all cases, the present invention offers a ready-to-make dessert kit whose components may be easily and quickly assembled by the consumer in any number of manners and combinations to fit his or her wishes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A food kit for components of a chilled or frozen dessert, said food kit having a plurality of compartments including a first compartment for a primary dessert component, a second compartment for a secondary dessert component such as a cookie or wafer, and a third compartment for a topping component such as fudge, syrup, or bits of candy wherein the user may manually assemble and combine the components of the dessert as desired.

2. A food kit for components of a chilled or frozen dessert, said food kit having a plurality of compartments wherein at least one of the compartments has a curved shape for holding a scoopable component of the dessert such as ice cream or yogurt, said food kit further including a second compartment for holding a component of the dessert such as a cookie or wafer, wherein the cookie or wafer has a curved shape and the curved shape of the compartment for the ice cream or yogurt substantially matches the curved shape of the cookie or wafer, and wherein the cookie or wafer may be used to scoop out the ice cream or yogurt from the compartment therefor.

3. The food kit of claim 2 wherein the curved shape of the compartment for the ice cream or yogurt includes a first substantially spherical section.

4. The food kit of claim 3 further including at least a second spherical section in said compartment for the ice cream or yogurt, said first and second spherical sections facing in two different directions wherein the cookie or wafer may be used by the consumer to scoop the ice cream or yogurt in at least two, different directions.

5. The food kit of claim 4 wherein said two directions are substantially perpendicular to each other.

6. The food kit of claim 3 further including at least a second substantially spherical section in said compartment for the ice cream or yogurt, said second spherical section substantially facing said first spherical section in an opposing manner.

7. The food kit of claim 2 wherein the second compartment has a substantially cylindrical portion and two opposing ear portions extending outwardly beyond the cylindrical portion, said second compartment holding a plurality of cookies or wafers stacked in the cylindrical portion thereof, said ear portions having surfaces sloping downwardly and inwardly to provide opposing spaces to permit the consumer to put his or her fingers on each side of a cookie in the stack to grip and remove the cookie.

8. The food kit of claim 7 further including a spoon positioned atop the stack of cookies in the second compartment wherein the opposing ends of the spoon are respectively received in the opposing ear portions of the second compartment.
